(19) United States
(12) Patent Application Publication
(10) Pub. No.: US 2009/0187454 A1
(43) Pub. Date: Jul. 23, 2009

(54) Computer Program Product For Efficient Scheduling Of Meetings

(75) Inventors: Irina Khasin, Acton, MA (US); Nancy E. Kho, Belmont, MA (US); Jane B. Marcus, Westford, MA (US); Terri A. Warren, Hampton, NH (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/017,971

(22) Filed: Jan. 22, 2008

(51) Int. Cl. G06F 17/00

(52) U.S. Cl. 705/9

(57) ABSTRACT

A computer program product for efficient scheduling of meetings including a computer usable medium having a computer readable program, wherein the computer readable program, when executed on a computer, causes the computer to obtain scheduling information of one or more potential meeting participants that includes a work schedule of the one or more potential meeting participants, a work office location of the one or more potential meeting participants during the work schedule, and a remote work schedule of when the one or more potential meeting participants will work remotely from the work office location during the work schedule; and to schedule a meeting based on the scheduling information, wherein a computer-accessible schedule notation of the meeting is created.

### BACKGROUND OF THE INVENTION

1. Field of the Invention

This invention relates generally to organizational management, and particularly to a computer program product for efficient scheduling of meetings.

2. Description of Background

Efficient scheduling of meetings is important for organizations such as corporate or government entities, and tools such as calendar or scheduling computer programs are often used for such purpose. However, the advent of flexible work options such as flexible work scheduling (e.g., “flextime”) and working from home or an alternate office location (e.g., “telecommuting”) has increased the complexity involved with efficient scheduling of meetings. For example, consideration of a potential meeting participant's flextime and/or telecommuting schedule is needed to efficiently schedule a meeting to insure the desired in-office or on-line participation. Therefore, tools such as scheduling programs are desirable that can assist with efficient scheduling of meetings for participants including those that utilize flexible work options such as flextime or telecommuting.

### SUMMARY OF THE INVENTION

A computer program product for efficient scheduling of meetings is provided. An exemplary embodiment of the computer program product includes a computer usable medium having a computer readable program, wherein the computer readable program, when executed on a computer, causes the computer to obtain scheduling information of one or more potential meeting participants that includes a work schedule of the one or more potential meeting participants, a work office location of the one or more potential meeting participants during the work schedule, and a remote work schedule of when the one or more potential meeting participants will work remotely from the work office location during the work schedule; and to schedule a meeting based on the scheduling information, wherein a computer-accessible schedule notation of the meeting is created,

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer system including an exemplary computing device configured for efficient scheduling of meetings.

FIG. 2 is a flow diagram illustrating an example of a method for efficient scheduling of meetings executable, for example, as a computer program product on the exemplary computing device of FIG. 1.

The detailed description explains the preferred embodiments of the invention, together with advantages and features, by way of example with reference to the drawings.

### DETAILED DESCRIPTION OF THE INVENTION

According to exemplary embodiments of the invention described herein, a computer program product for efficient scheduling of meetings is provided. In accordance with such exemplary embodiments, efficient scheduling of meetings can be made with consideration of factors including flexible work options (such as flextime or telecommuting) of participants, meeting time preferences of participants, and meeting participation preferences (e.g., in-office or on-line).

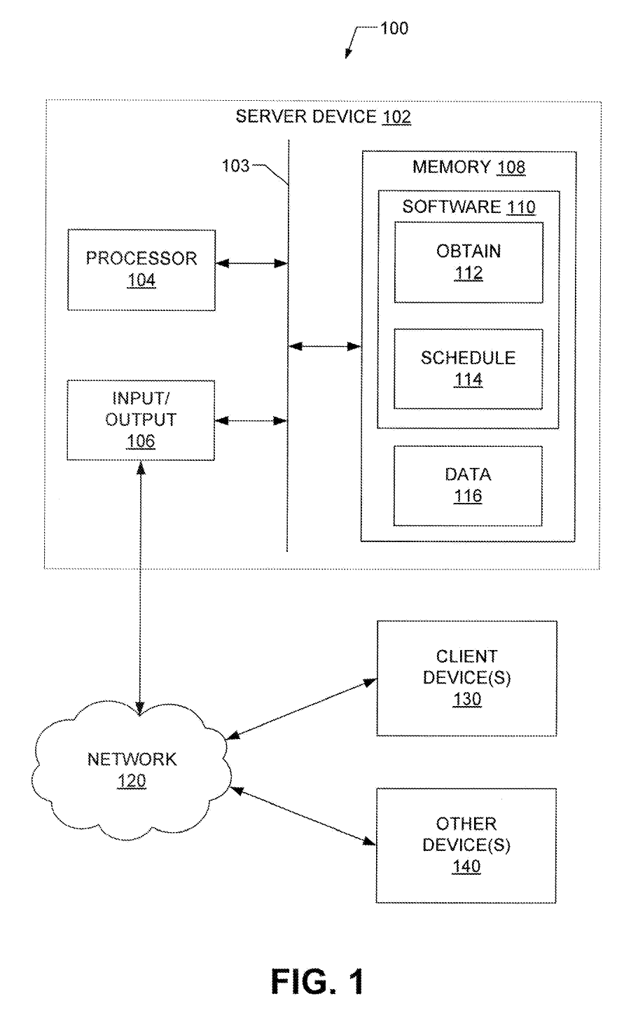

Turning now to the drawings in greater detail, wherein like reference numerals indicate like elements, FIG. 1 illustrates an example of a computer system 100 including an exemplary computing device (“server device”) 102 configured for efficient scheduling of meetings. In addition to computing device 102, exemplary computer system 100 includes network 120, client device(s) 130, and other device(s) 140. Network 120 connects server device 102, client device(s) 130, and other device(s) 140 and may include one or more wide area networks (WANs) and/or local area networks (LANs) such as the Internet, intranet(s), and/or wireless communications network(s). Client device(s) 130 may include one or more other computing devices, e.g., that are similar to server device 102. Other device(s) 140 may include one or more other computing devices, e.g., one or more other server devices, storage devices, etc. Server device 102, client device(s) 130, and other device(s) 140 are in communication via network 120, e.g., to communicate data between them.

Exemplary server device 102 includes processor 104, input/output component(s) 106, and memory 108, which are in communication via bus 103. Input/output component(s) 106 may include one or more components that facilitate local and/or remote input/output operations to/from server device 102, such as a display, keyboard, modem, network adapter, etc. (not depicted). Memory 108 includes software 110 for efficient scheduling of meetings, which is executable, e.g., by server device 102 via processor 104. Software 110 includes modules for efficient scheduling of meetings, including obtain module 112 and schedule module 114. An exemplary operation of these modules 112, 114 will be described below. Memory 108 also includes data 116 that can be utilized, e.g., by software 110 via processor 104. Memory 108 may include other software, modules, etc. (not depicted).

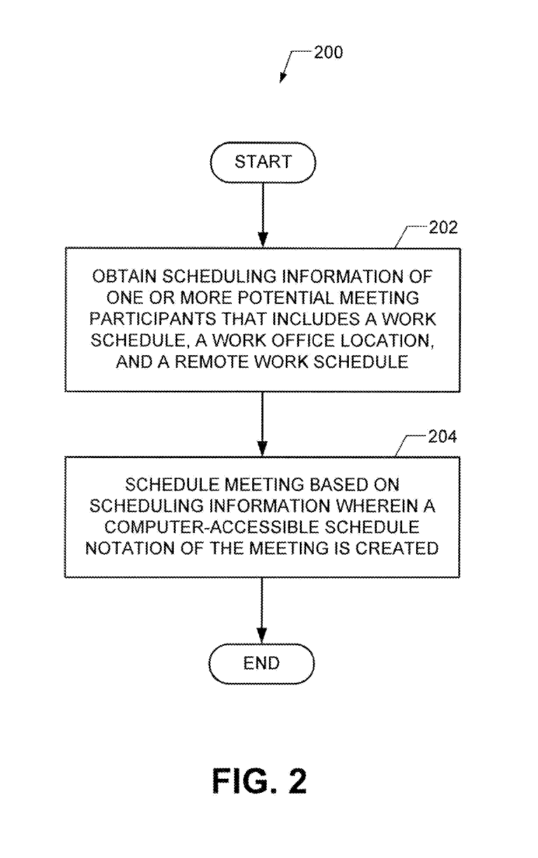

FIG. 2 illustrates an example of a method 200 for efficient scheduling of meetings executable, for example, as a computer program product on the exemplary server device 102 of FIG. 1. In block 202, scheduling information of one or more potential meeting participants is obtained that includes a work schedule of the one or more potential meeting participants, a work office location of the one or more potential meeting participants during the work schedule, and a remote work schedule of when the one or more potential meeting participants will work remotely from the work office location during the work schedule. The scheduling information may be obtained by being received, collected, etc. This may be performed, e.g., by obtain module 112 of software 110 executed on server device 102, and the scheduling information may be communicated to server device 102, e.g., from client device(s) 130 and/or other device(s) 140 and stored in memory 108 as data 116. In some embodiments, the scheduling information may be additionally or alternatively stored in a database or other persistent storage device, such as other devices 140.

The work schedule may include the days and/or times during a period, such as a week, that a potential meeting participant usually works (e.g., Monday through Friday, 9 AM to 6 PM each day); this work schedule may include a flextime option. The work office location may include the usual office location where a potential meeting participant works and may, e.g., be obtained (e.g., dependent on a scheduling administrator configuration) from a lightweight directory access protocol (LDAP) directory, an internet-accessible information system, a database (e.g., local or remote), or a computer-accessible file. The remote work schedule may include the days and/or times during the work schedule (e.g., Monday and Friday) that the potential meeting participant works remotely from the work office location, such as at home or another office location (e.g., by telecommuting). Obtaining the scheduling information may also include obtaining dynamic changes to the scheduling information. For example, a potential meeting participant may change his scheduling information for a particular time period (e.g., hour, day, week, etc.) to reflect his updated plans, and this change can override the previously obtained (e.g., default) scheduling information for the potential meeting participant. Potential meeting participants can, for example, provide their scheduling information via a user interface that supports keywords (e.g., that are supplied by an administrator) for ease of use to submit their work office location. For example, the keyword “Boston” may be used to indicate a corporate work office location in Boston and the keyword “home” may be used to indicate a work office location that is not associated with a corporate office (e.g., a home or residence based work office location).

In some embodiments, the obtained scheduling information may also include a non-interruption schedule of when the one or more potential meeting participants should not be scheduled to meet during the work schedule, and a preferred meeting time schedule of when the one or more potential meeting participants prefer to meet during the work schedule. For example, the non-interruption schedule may include the days and/or times during the work schedule that the potential meeting participant prefers not to meet or is otherwise usually unavailable to meet (e.g., Monday through Friday, 9 AM to 9:30 AM and 12 PM to 12:30 PM). The preferred meeting time schedule may include the days and/or times during the work schedule that the potential meeting participant prefers to meet or is otherwise usually available to meet (e.g., Tuesday through Thursday, 9:30 AM to 11:30 AM and 2 PM to 4 PM).

In block 204, a meeting is scheduled based on the scheduling information wherein a computer-accessible schedule notation of the meeting is created. This may be performed, e.g., by schedule module 114 of software 110 executed on server device 102, and the scheduled meeting information (e.g., data 116 in memory 108) may be communicated from server device 102 to, e.g., client device(s) 130 and/or other device(s) 140. In some embodiments, scheduling the meeting may include receiving a meeting criteria that includes the one or more potential meeting participants and at least one of a meeting date, a meeting duration, or a meeting location, searching for and presenting an available meeting time based on the meeting criteria and the scheduling information, and scheduling the meeting based on the meeting criteria in response to a selection of the available meeting time. For example, the obtained meeting criteria may include the names of potential meeting participants that are desired to participate in the meeting and a desired meeting date and meeting duration (e.g., Nov. 14, 2007 for one hour). Based on the meeting criteria and the scheduling information, one or more available meeting times can be identified by a search (e.g., by a search engine via schedule module 114) and presented for selection (e.g., via input/output components) of client device(s) 130 and/or other device(s) 140). A meeting can be scheduled (e.g., including participants, date, start/end times, etc.) based on the meeting criteria in response to a selection of one of the available meeting times.

In some embodiments, the obtained meeting criteria may also include a designation of the one or more potential meeting participants as a critical participant or an optional participant, and a search preference for the available meeting time when either the critical participant and the optional participant are available to meet at the meeting location, at least the critical participant is available to meet at the meeting location, or at least the optional participant is available to meet at the meeting location. For example, the participation of some of the potential (e.g., desired) meeting participants may be required to conduct the meeting and, thus, such desired meeting participants are designated as critical participants, while the participation of other desired meeting participants may not be required to conduct the meeting and, thus, such desired meeting participants are designated as optional participants. A search preference may be included in the meeting criteria in that regard for an available meeting time when all of the desired meeting participants (i.e., both critical and optional participants) are available to participate in the meeting, at least the designated critical participants are available to participate, or at least the optional participants are available to participate. Thus, a search can be performed, e.g., to schedule a meeting when either critical participants, optional participants, or both are available at a desired meeting location, such as in-office.

In some embodiments, scheduling the meeting may also include searching for and presenting an available meeting location based on the meeting criteria, the scheduling information, and a quantity of the one or more potential meeting participants, and scheduling an on-line meeting for any of the one or more potential meeting participants who will be remote to the available meeting location or who cannot be accommodated by the available meeting location, wherein the on-line meeting is scheduled for all of the one or more potential meeting participants if there is no available meeting location. For example, in addition or alternatively to an available time, an available meeting location may be searched and presented for selection to schedule the meeting, where the available meeting location may be searched based on the meeting criteria, the scheduling information of the one or more potential meeting participants, and the quantity of potential meeting participants. In that regard, the quantity of potential meeting participants may be determined based on the meeting participants that are available to meet at the meeting location (e.g., at the available meeting time) based on the meeting criteria in consideration of the scheduling information. Furthermore, for those potential meeting participants that are not available to meet at the meeting location or cannot be accommodated by the meeting location (e.g., due to a lack of sufficient meeting space, resources, etc.), an on-line meeting (e.g., via network 120) is scheduled. Moreover, in the event that there are no available meeting locations resulting from the search, an on-line meeting is scheduled for all of the potential meeting participants.

The created computer-accessible schedule notation of the meeting may, e.g., include a calendar entry and/or other notification that can be communicated via input/output component(s) of server device 102, client device(s) 130 and/or other device(s) 140. The schedule notation may include information such as the potential meeting participants, the scheduled date, time, and duration of the meeting, the meeting location, and/or other information relative to the scheduled meeting.

The foregoing exemplary blocks 202, 204 of method 200 may include communications via one or more graphical user interfaces, e.g., via server device 102, client device(s) 130, and/or other device(s) 140. Furthermore, exemplary computer system 100 and server device 102 are illustrated and described with respect to various components, modules, etc. for exemplary purposes. It should be understood that other variations, combinations, or integrations of such elements that provide the same features, functions, etc. are included within the scope of embodiments of the invention.

The flow diagram described herein is just an example. There may be many variations to this diagram or the blocks (or operations) thereof without departing from the spirit of embodiments of the invention. For instance, the blocks may be performed in a differing order, or blocks may be added, deleted or modified. All of these variations are considered a part of the claimed invention. Furthermore, although an exemplary execution of the flow diagram blocks is described with respect to the exemplary computer system 100 and server device 102, execution of the flow diagram blocks may be implemented with other hardware and/or software architectures that provide the same features, functions, etc. in accordance with exemplary embodiments of the invention.

Exemplary embodiments of the invention can be implemented in hardware, software, or a combination of both. Those embodiments implemented in software may, for example, include firmware, resident software, microcode, etc. Exemplary embodiments of the invention may also be implemented as a computer program product accessible from a computer-usable or computer-readable medium providing program code for rise by or in connection with a computer or other instruction execution system. In this regard, a computer-usable or computer-readable medium can be any apparatus that can contain, store, communicate, propagate, or transport the program for use in connection with the instruction execution system, apparatus, or device.

The computer-usable or computer-readable medium can be an electronic, magnetic, optical, electromagnetic, infrared, or semiconductor system (apparatus, device, etc.) or a propagation medium. Examples of a computer-readable medium include a semiconductor or solid state memory, magnetic tape, a removable computer diskette, a random access memory (RAM), a read-only memory (ROM), a rigid magnetic disk, or an optical disk. Some current examples of optical disks include compact disk-read only memory (CD-ROM), compact disk-read/write (CD-R/W), or digital video disk (DVD).

A data processing system suitable for storing and/or executing program code can include at least one processor coupled directly or indirectly to memory elements through a system bus. The memory elements can include local memory employed during actual execution of the program code, bulk storage, or cache memories that provide temporary storage of at least some program code to reduce the number of times the code needs to be retrieved from bulk storage during execution.

Input/output (I/O) devices (e.g., keyboards, displays, pointing devices, etc.) can be coupled to the data processing system either directly or through intervening I/O controllers. Network adapters may also be coupled to the data processing system to allow the system to be coupled to other data processing systems or remote printers or storage devices through intervening private or public networks. Telephonic modems, cable modems, and ethernet cards are a few examples of the currently available types of network adapters.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

What is claimed is:

1. A computer program product for efficient scheduling of meetings, comprising a computer usable medium having a computer readable program, wherein the computer readable program, when executed on a computer, causes the computer to:
obtain scheduling information of one or more potential meeting participants, wherein the scheduling information comprises:
a work schedule of the one or more potential meeting participants;
a work office location of the one or more potential meeting participants during the work schedule, wherein the work office location is obtained from a lightweight directory access protocol (LDAP) directory, an internet-accessible information system, a database, or a computer-accessible file; and
a remote work schedule of when the one or more potential meeting participants will work remotely from the work office location during the work schedule,
wherein obtaining the scheduling information includes obtaining dynamic changes to the scheduling information; and
schedule a meeting based on the scheduling information, wherein a computer-accessible schedule notation of the meeting is created.

2. The computer program product of claim 1, wherein the scheduling information further comprises:
a non-interruption schedule of when the one or more potential meeting participants should not be scheduled to meet during the work schedule; and
a preferred meeting time schedule of when the one or more potential meeting participants prefer to meet during the work schedule.

3. The computer program product of claim 1, wherein the computer readable program, when executed on the computer, causes the computer to schedule a meeting by:
receiving a meeting criteria that includes the one or more potential meeting participants and at least one of a meeting date, a meeting duration, or a meeting location;
searching for and presenting an available meeting time based on the meeting criteria and the scheduling information; and
scheduling the meeting based on the meeting criteria in response to a selection of the available meeting time.

4. The computer program product of claim 3, wherein the meeting criteria further comprises:
a designation of the one or more potential meeting participants as a critical participant or an optional participant; and
a search preference for the available meeting time when either the critical participant and the optional participant are available to meet at the meeting location, at least the critical participant is available to meet at the meeting location, or at least the optional participant is available to meet at the meeting location.

5. The computer program product of claim 3, wherein the computer readable program, when executed on the computer, further causes the computer to:
search for and present an available meeting location based on the meeting criteria, the scheduling information, and a quantity of the one or more potential meeting participants; and
schedule an on-line meeting for any of the one or more potential meeting participants who will be remote to the available meeting location or who cannot be accommodated by the available meeting location, wherein the on-line meeting is scheduled for all of the one or more potential meeting participants if there is no available meeting location.
